(19) United States
(12) Patent Application Publication
(10) Pub. No.: US 2024/0307767 A1
(43) Pub. Date: Sep. 19, 2024

(54) Cloud Data Processing

(71) Applicant: Tencent Technology (Shenzhen) Company Limited, Shenzhen (CN)

(72) Inventors: Xinda ZHAO, Shenzhen (CN); Jingyang Liu, Shenzhen (CN); Zhipeng Gong, Shenzhen (CN); Yandong Yang, Shenzhen (CN)

(21) Appl. No.: 18/675,247

(22) Filed: May 28, 2024

Related U.S. Application Data
(63) Continuation of application No. PCT/CN2023/097301, filed on May 31, 2023.

(30) Foreign Application Priority Data
Aug. 17, 2022 (CN) 2022109844611

(51) Int. Cl. A63F 13/355; G06T 15/00; G06T 15/04; H04L 67/10

(52) U.S. Cl. CPC A63F 13/355; G06T 15/005; G06T 15/04; H04L 67/10

(57) ABSTRACT

Aspects described herein provide a data processing method and apparatus, a device, and a medium. The method is performed by a server. The server includes a plurality of cloud application clients. Data transmission processes of the plurality of cloud application clients are isolated from each other. The plurality of cloud application clients include a first cloud application client. The method includes: starting the first cloud application client deployed in the server; and transmitting an application data stream of a first cloud application between the first cloud application client and a first terminal through a data collection component in the first cloud application client. A usage rate of the server can be increased, thereby reducing usage costs of a cloud application.

### CROSS-REFERENCE TO RELATED APPLICATIONS

This application claims priority to PCT Application PCT/CN2023/097301, filed May 31, 2023, which claims priority to Chinese Patent Application No. 2022109844611, filed with the China National Intellectual Property Administration on Aug. 17, 2022 and entitled “DATA PROCESSING METHOD AND APPARATUS, DEVICE, AND MEDIUM”, each of which is incorporated herein by reference in its entirety.

### FIELD OF THE TECHNOLOGY

This application relates to the technical field of cloud applications, and in particular, to a data processing technology in the cloud applications.

### BACKGROUND OF THE DISCLOSURE

A cloud application is an application based on cloud computing. In a running mode of the cloud application, all applications run on a server side. Rendered content is compressed and then transmitted to a user side through a network. In a current usage scenario of the cloud application, the cloud application usually runs in a virtualized environment on the server side. Content rendered on the server side is transmitted to a corresponding display buffer (a framebuffer) of a display device in the virtualized environment, and then the content in the display buffer is read and transmitted to the user side by a specific application. Operation data of the user side for the cloud application may be transmitted to an input device in the virtualized environment, and then the server side can obtain the corresponding operation data from the input device and inject the operation data into the cloud application.

Generally, one display device and one input device may be deployed in one virtualized environment. When a plurality of users simultaneously use cloud applications, a plurality of virtualized environments need to be run on the server side. In this way, data isolation can be ensured between the cloud applications used by the users. The mode in which one virtualized environment supports running of only one cloud application client causes high usage costs of a cloud application.

### SUMMARY

The following disclosure relates to ways that can increase a usage rate of a server, thereby reducing usage costs of a cloud application.

Aspects of the disclosure include data processing method performed by a server, a plurality of cloud application clients being deployed in the server, data transmission processes of the plurality of cloud application clients being isolated from each other, and the plurality of cloud application clients including a first cloud application client. According to various aspects of the disclosure, methods may include starting the first cloud application client deployed in the server. An application data stream of a first cloud application may be sent or transmitted between the first cloud application client and a first terminal through a data collection component in the first cloud application client.

Various aspects of this application provide for one or more data processing apparatus operating in a computing device. Additionally, aspects may include a plurality of cloud application clients deployed in the server, data transmission processes of the plurality of cloud application clients being isolated from each other, and the plurality of cloud application clients including a first cloud application client. According to various aspects, example apparatus may include a first start module, configured to start the first cloud application client deployed in the server. The apparatus may also include a first transmission module, configured to transmit an application data stream of a first cloud application between the first cloud application client and a first terminal through a data collection component in the first cloud application client.

According to various aspects of this disclosure, a computer device is provided. The computer device may including memory and one or more processors. Additionally, the memory may be connected to the processor and configured to store one or more computer programs. The one or more processors may also be configured to call the one or more computer programs, causing the computer device to perform the method provided in the above aspect of the aspects of this application.

Aspects of this disclosure also include computer-readable storage media, having one or more computer programs stored therein. The one or more computer programs may be adapted to be loaded and executed by one or more processors, to cause a computer device having the processor to perform the method provided in the above aspect of the this application.

According aspects of this application, a computer program product or a computer program is provided, including computer instructions, the computer instructions being stored in a computer-readable storage medium, a processor of a computer device reading the computer instructions from the computer-readable storage medium, and the processor executing the computer instructions, to cause the computer device to perform the method provided in the above aspect.

According to various aspects, a plurality of cloud application clients may be created on the server side, the data transmission processes of the plurality of cloud application clients are isolated from each other, and the plurality of cloud application clients include the first cloud application client. During specific implementation, the first cloud application client deployed in the server may be started, and the application data stream of the first cloud application between the first cloud application client and the first terminal can be transmitted through the data collection component in the first cloud application client. The first terminal is configured to output cloud application content corresponding to the first cloud application client. Through the data collection component integrated in the first cloud application client, data transmission can be directly performed between the first cloud application client running in the server and the first terminal. Correspondingly, through the data collection components respectively integrated inside the cloud application clients, isolation can be achieved between the application data streams of the cloud application clients. To be specific, it is ensured that data exchange between the plurality of cloud application clients on the same server side and corresponding terminal devices thereof is independent and does not affect each other. In this way, during running of a plurality of cloud application clients on the server side, data isolation can be achieved without a need to arrange a plurality of virtualized environments. Therefore, a usage rate of the server can be increased, and usage costs of the cloud application can be reduced.

### BRIEF DESCRIPTION OF THE DRAWINGS

FIG. 1 is an architectural diagram of a processing system of a cloud application according to various aspects of the disclosure.

FIG. 2 is a schematic diagram of a data exchange scenario of a cloud game according to various aspects of the disclosure.

FIG. 3 is a schematic flowchart of a data processing method according to various aspects of the disclosure.

FIG. 4 is a schematic diagram of data exchange of a cloud application according to various aspects of the disclosure.

FIG. 5 is a schematic flowchart of another data processing method according to various aspects of the disclosure.

FIG. 6 is a schematic diagram of capturing image data by a rendering capturing component integrated inside a cloud application client according to various aspects of the disclosure.

FIG. 7 is a schematic diagram of compression processing of image data in a cloud application client according to various aspects of the disclosure.

FIG. 8 is a schematic structural diagram of data compression of a cloud application client in a server according to various aspects of the disclosure.

FIG. 9 is a schematic diagram of receiving object operation data by an operation processing component integrated inside a cloud application client according to various aspects of the disclosure.

FIG. 10 is a schematic structural diagram of a data processing apparatus according to various aspects of the disclosure.

FIG. 11 is a schematic structural diagram of a computer device according various aspects of the disclosure.

### DETAILED DESCRIPTION

Technical solutions in aspects of this application are described below with reference to drawings in the aspects of this application. The described aspects are example aspects rather than all of the aspects within the scope of this application. All other aspects obtained by a person of ordinary skill in the art based on the aspects of this application without creative efforts fall within the protection scope of this application.

The aspects of this application involve cloud computing and cloud applications. The cloud computing is a computing mode in which computing tasks are distributed across a resource pool composed of a large quantity of computers to enable various application systems to obtain computing power, storage spaces, and information services as required. A network that provides resources is referred to as “cloud”. The resources in the “cloud” can be infinitely expanded in the eyes of users, and can be obtained at any time, used on demand, expanded at any time, and paid for use. A basic capability provider for the cloud computing establishes a cloud computing resource pool platform (referred to as a cloud platform for short, which is generally referred to as infrastructure as a service (IaaS)). Various virtual resources are deployed in a resource pool for selection and use by external users. The cloud computing resource pool mainly includes computing devices (which are virtualized machines, including operating systems), storage devices, and network devices.

Cloud applications are a subset of the cloud computing, and are an implementation of the cloud computing technology at an application layer. Cloud applications are new applications that work to change a traditional way to use software, i.e., local installation and local operation of the software, to a ready to use service. In cloud applications, a remote server cluster is operated and controlled over the Internet or a local area network to complete a service logic or an operation task. An advantage of cloud applications is as follows. An application (for example, a cloud application client) of the cloud application runs on a server side, the server side performs a computing task of the cloud application such as data rendering, and then transmits a computing result of the cloud application to a user client in a terminal device for display, and the user client can collect user operation information (which may also be referred to as object operation data of the cloud application, or may be referred to as input event data of the cloud application), and transmit the operation information to the cloud application client of the server side to implement control of the cloud application by the server side. Cloud application clients involved in the aspects of this application are all cloud application instances running on the server side. The user client may be a client that may be installed in the terminal device and can provide a corresponding cloud application experience service for a user. In short, the user client may be configured to output a cloud application display page corresponding to the cloud application client, which may also be referred to as a cloud application user client. The user client is not described below. The cloud application may include cloud gaming, cloud education, cloud security, cloud conferencing, cloud calling, cloud social, and the like. As a typical instance of the cloud application, the cloud gaming gets increasing attention in recent years.

The cloud gaming may also be referred to as gaming on demand, and is an online gaming technology based on the cloud computing technology. The cloud gaming technology enables a thin client with relatively limited graphics processing and data computing capabilities to run a high-quality game. During a cloud game, a game is not on a game terminal used by a user, and only a user client runs in the game terminal. A real game application (for example, a cloud game client) runs on a server side, and the server side renders page display data in the cloud game into an audio/video code stream, and transmits the rendered audio/video code stream to the user client in the game terminal, and the user client outputs and displays the received audio/video code stream. The game terminal is not required to have powerful graphics computing and data processing capabilities, and is only required to have a basic streaming media playback capability and a capability of obtaining input event data of the user and transmitting the input event data to the cloud game client. When playing a cloud game, a user is actually performing an operation on an audio/video code stream of the cloud game. For example, the user generates input event data (which is also referred to as object operation data, or may be referred to as a user operation instruction) through a touchscreen, a keyboard, a mouse, a joystick, or the like, and then transmits the input event data to the cloud game client on the server side through a network, so as to implement an operation on the cloud game.

The game terminal involved in this application may be a terminal device used by a player for experiencing a cloud game, that is, a terminal device having a user client corresponding to the cloud game client installed therein. The player herein may be a user that is playing a cloud game or that requests to play a cloud game. The audio/video code stream may include an audio stream and a video stream generated by the cloud game client. The audio stream may include audio data generated during running of the cloud game client. The video stream may include image data rendered during running of the cloud game. For example, the video stream may be considered as a video composed of a series of game pictures (that is, rendered image data) rendered in the cloud game client. In this case, the image data may be considered as video frames in the video stream.

During running of the cloud application (for example, the cloud game), communication connection (which may specifically be communication connection between the cloud application client and the user client in the terminal device) between the cloud application client on the server side and the terminal device (for example, the game terminal) is involved. After the communication connection between the cloud application client and the terminal device is successfully established, a cloud application data stream in the cloud application can be transmitted between the cloud application client and the terminal device. For example, the cloud application data stream may include a video stream (including a series of image data generated during running of the cloud application client) and an audio stream (including audio data generated during running of the cloud application client). For ease of understanding, the audio data herein and the above image data may be collectively referred to as audio/video data. In this case, the cloud application client can transmit the video stream and the audio stream to the terminal device. For another example, the cloud application data stream may include object operation data for the cloud application obtained by the terminal device. In this case, the terminal device can transmit the object operation data to the cloud application client running on the server side.

Basic concepts involved in the aspects of this application are described below, in the form of non-limiting examples.

Virtual machine: It virtualizes an operating system. The operating system runs in a hardware environment associated or emulated through software (for example, QEMU (a virtual operating system simulator)), and has an independent kernel mode and user mode.

Container: It virtualizes an operating system. A plurality of operating systems share the same kernel in a kernel mode through a kernel mode isolation mechanism, and remain independent of each other in a user mode.

Cloud application instance: On a server side, a set of software that includes complete cloud application functions may be referred to as a cloud application instance. For example, a set of software that includes complete cloud game functions may be referred to as a cloud game instance.

Personal computer (PC) cloud gaming: A Guest operating system usually may be a Windows or Linux system. A cloud game application runs in the Windows or Linux system. The Guest operating system may be an operating system that runs in a virtual machine or a container. The virtual machine or the container can run in a general operating system. The general operating system may be referred to as a host operating system.

Rendering buffer: A cloud application client running on a server side calls a rendering interface provided by a graphics processing unit (GPU) driver to perform a rendering operation. An area configured to store rendered image data may be referred to as a rendering buffer. The rendering buffer may be a GPU video memory allocated by the server to the cloud application client, which is a component configured to store the image data rendered by the cloud application client. The rendering buffer functions like an internal memory of a computer.

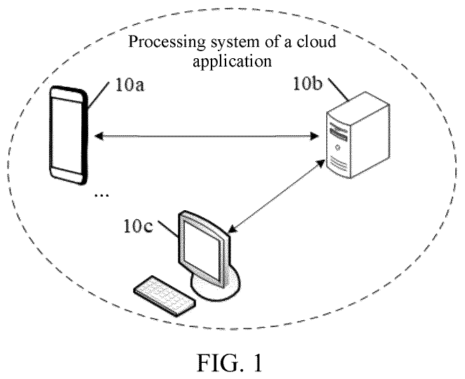

FIG. 1 is an architectural diagram of a processing system of a cloud application according to an embodiment of this application. As shown in FIG. 1, the processing system of the cloud application may include a terminal device 10a, a terminal device 10c, a server 10b, and the like. A quantity of terminal devices and a quantity of servers in the processing system of the cloud application shown in FIG. 1 are merely an example. In an actual application scenario, a specific quantity of terminal devices and a specific quantity of servers in the processing system of the cloud application may be determined as required. For example, one or more terminal devices and one or more servers may be arranged. The quantity of terminal devices and the quantity of servers are not limited in this application.

An application (e.g., a cloud application client) of a cloud application may run in the server 10b. The server 10b may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. A type of the server 10b is not limited in this application.

The terminal device 10a and the terminal device 10c each include a user client associated with the cloud application client in the server 10b. The terminal device 10a and the terminal device 10c each may include electronic devices such as a smartphone (such as an Android phone or an iOS phone), a desktop computer, a tablet computer, a portable personal computer, a mobile internet device (MID), a wearable device (such as a smartwatch or a smart bracelet), and on-board device. Types of the terminal devices in the processing system of the cloud application are not limited in this embodiment of this application.

FIG. 1 is an example of a system according to various aspects of the disclosure. As shown in FIG. 1, one or more cloud application clients (one cloud application client herein may be considered one cloud application instance) can run in the server 10b. One cloud application client corresponds to one user. In other words, one cloud application client may correspond to one terminal device. The one or more cloud application clients running in the server 10b may be the same cloud application, or may be different cloud applications. For example, when a user A and a user B use a cloud application 1 at the same time, a cloud application 1 instance may be created for each of the user A and the user B in the server 10b. When the user A and the user B use different cloud applications at the same time (for example, the user A uses a cloud application 1, and the user B uses a cloud application 2), a cloud application 1 instance may be created for the user A and a cloud application 2 instance may be created for the user B in the server 10b.

The terminal device 10a and the terminal device 10c each may be an electronic device used by a user. The user herein may be an object that is using the cloud application or that requests to use the cloud application. One or more user clients may be integrated in one terminal device, and each user client can establish communication connection with a corresponding cloud application client in the server 10b. The user client and the corresponding cloud application client thereof can perform data exchange through the communication connection. A user client in the terminal device 10a can receive, based on the communication connection, audio/video data (which may, for example, include image data and audio data corresponding to the cloud application client) transmitted by the cloud application client, and output the received audio/video data. Correspondingly, the terminal device 10a can transmit obtained object operation data to the corresponding cloud application client, so that the cloud application client on the server side can execute a corresponding service logic based on the object operation data.

It may be understood that, in a cloud application scenario, the cloud application clients all run on the server side. In order to reduce cloud application costs, a typical method is to increase a quantity of cloud application instances running in a single server. One cloud application instance may be considered as one cloud application client, and one cloud application client corresponds to one user. In this embodiment of this application, the processing system of the cloud application shown in FIG. 1 may be applied in a concurrent cloud application running scenario of a single server (which may be understood as that a plurality of cloud application instances simultaneously run in a single server) in a single server, and a plurality of cloud application clients on a server side (for example, the server 10b) may run in a virtual machine, a container, or a virtualized environment of another type provided by the server, or may run in a non-virtualized environment provided by the server (for example, directly run on a real operating system of the server side), which is not limited in this application. The plurality of cloud application clients running in the server 10b may share physical GPU hardware corresponding to the server 10b. Each cloud application client running in the server 10b can directly perform data transmission with a user client in the corresponding terminal device thereof through a specific functional component (for ease of understanding, the specific functional component herein may be referred to as a data collection component) integrated inside the cloud application client.

In this embodiment of this application, a data transmission process of the cloud application client includes data transmission from the cloud application client to the user client and data transmission from the user client to the cloud application client. The user client herein is a client corresponding to a cloud application running in the terminal device. The data transmission from the cloud application client to the user client is configured to transmit data (for example, image data and audio data.) generated by the cloud application client to the user client. In other words, the data is transmitted by the server to the terminal device. The data transmission from the user client to the cloud application client is configure to transmit data (for example, user input data) collected by the user client to the cloud application client. In other words, the data is transmitted by the terminal device to the server.

For example, if the plurality of cloud application clients on the server side (for example, the server 10b) all run in the same virtual machine provided by the server, a data collection component is integrated in each cloud application client running in the virtual machine. The data collection component integrated inside any cloud application client can capture audio/video data generated by the cloud application client, and directly transmit the audio/video data to the user client in the corresponding terminal device. In other words, the transmission process of the audio/video data generated by the cloud application client does not need an interactive operation with a display device, an audio device, and the like corresponding to the virtual machine. Likewise, object operation data (which may be referred to as input event data, such as an operation instruction inputted by a user in the user client of the terminal device) generated by the user client in the terminal device can be directly transmitted from the user client to the data collection component integrated inside the corresponding cloud application client. When another component in the cloud application client (a component in the cloud application client other than the data collection component) needs to call the object operation data, the object operation data may be directly called from the data collection component. In other words, the transmission of the object operation data does not need an interactive operation with an input device corresponding to the virtual machine. In this way, interactive operations during data transmission between the cloud application client and the user client in the terminal device can be reduced, thereby improving performance and a response speed.

The cloud application client running on the server side usually needs exclusive occupation of the display device, the audio device, and the input device. In an existing concurrent running scenario of the cloud application, one display device, one audio device, and one input device need to be emulated for each virtual machine of the server side (the server side usually has no display device, audio device, and input device). In other words, one virtual machine corresponds to one display device, one audio device, and one input device. For example, in an existing technical solution, image data rendered by a cloud application client C1 (which may be considered as a cloud application client running in any virtual machine of the server side) is finally transmitted to a display buffer (a framebuffer) corresponding to a display device D1 (a display device corresponding to the virtual machine that runs the cloud application client C1). In this case, an independent capturing program in the virtual machine reads content in the display buffer corresponding to the cloud application client C1, to ensure that the content captured by the independent capturing program is the image data corresponding to the cloud application client C1 rather than image data corresponding to another cloud application client (a cloud application client on the server side other than the cloud application client C1). To be specific, one virtual machine corresponds to one emulated display device. The virtual machine includes an independent capturing program. The independent capturing program reads content in a display buffer corresponding to a display device of a current virtual machine, to capture image data from a cloud application client running in the current virtual machine. In other words, in the existing technical solution, one display device needs to be emulated for the virtual machine, and one virtual machine may run only one cloud application client, to achieve isolation between image data corresponding to different cloud application clients. The display buffer may be configured to drive a corresponding display device thereof. The display buffer can function like a video card. The display buffer is read and written to directly perform an operation on a video memory. Similar to the function of the above display device, in the existing technical solution, one audio device needs to be emulated for the virtual machine to achieve isolation between audio data corresponding to different cloud application clients, and one input device needs to be emulated for each virtual machine to achieved isolation between object operation data corresponding to different cloud application clients.

In some aspects, the plurality of cloud application clients running in the server side can perform a rendering operation in respective processes in which the cloud application clients are located. Rendered image data may be stored in a rendering buffer. Through an independent data collection component integrated inside each cloud application client, the rendered image data can be directly read from a rendering buffer corresponding to a current cloud application client. The data collection component can directly capture audio data corresponding to the image data generated by the current cloud application client, and directly transmit the captured image data and audio data to the terminal device for output. In other words, the image data and the audio data in this embodiment of this application are independently generated in the process of each cloud application client, and the capturing process of the image data and the audio data corresponding to the cloud application client is completed by the data collection component integrated inside the cloud application client. In other words, the generation process and the capturing process of the image data and the audio data are all completed in the cloud application client. In this way, the image data and the audio data captured through the data collection component are necessarily audio/video data corresponding to the current cloud application client, and data confusion does not exist. Similarly, the object operation data generated by the terminal device can be directly transmitted to the data collection component integrated inside the cloud application client. The object operation data in the data collection component may be called by another component in the cloud application client. In this embodiment of this application, through the data collection component integrated inside the cloud application client, data isolation can be achieved between different cloud application clients, which avoids exclusive occupation of the display device, the input device, the audio device, and the like by the cloud application client, so that in a data transmission process, interactive operations can be reduced, and data transmission paths can be reduced, thereby improving the performance and the response speed. In addition, since the data transmission between each cloud application client and the corresponding terminal device can be completed by the data collection components integrated inside the cloud application client, in the technical solution provided in this embodiment of this application, a plurality of cloud application clients can concurrently run in a virtual machine provided by the server side or directly concurrently run in the non-virtualized environment of the server side. In this way, a central processing unit (CPU) computing power loss caused by starting a plurality of virtual machines on the server side can be avoided, a utilization rate of the server can be increased, and costs of the cloud application can be reduced.

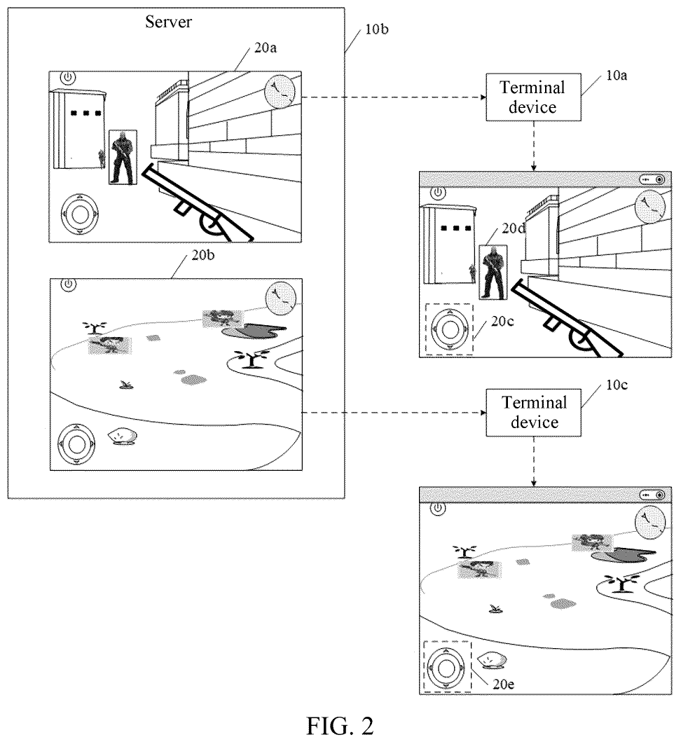

For ease of understanding, data exchange processes between the server 10b and the terminal device 10a and the terminal device 10c in the processing system of the cloud application are described below by using an example in which the cloud application is a cloud game. FIG. 2 is a schematic diagram of an example data exchange scenario of a cloud game according to various aspects of the disclosure. Two or more cloud application clients may run in the server 10b shown in FIG. 2. The terminal device 10a may be an electronic device used by the user A. One or more user clients associated with cloud games of different types may be integrated in the terminal device 10a. The user clients herein each may be understood as a client that is installed in the terminal device and can provide a corresponding cloud game experience service for the user. For example, if a user client 21 in the terminal device 10a is a client associated with a cloud game 1, an icon of the user client 21 in the terminal device 10a may be an icon of the cloud game 1. The user client 21 can provide a cloud game 1 experience service for the user. In other words, the user can play the cloud game 1 through the user client 21 in the terminal device 10a.

When a user A wants to play the cloud game 1, the user may perform a triggering operation on the user client 21 in the terminal device 10a. In this case, the terminal device 10a can obtain, in a connected state, a start instruction generated in the user client 21 in response to a start operation performed on the user client 21, and then transmit the start instruction to the server 10b. In this case, a cloud game 1 instance may be created for or allocated to the user A in the server 10b (that is, a cloud game client 22 corresponding to the cloud game 1 may be created for or allocated to the user A), and the cloud game client 22 corresponding to the user A is run in the server 10b. In addition, the user client 21 in the terminal device 10a is also successfully started. To be specific, the user client 21 in the terminal device 10a remains the same running state as the cloud game client 22 in the server 10b. It is to be understood that, if the cloud game 1 instance is pre-deployed in the server 10b, after receiving the start instruction from the user client 21, the server 10b may allocate the cloud game 1 instance to the user A from the server 10b, and start the cloud game 1 instance. In this way, a start time of the cloud game I can be reduced, so that a time of waiting for the user client 21 to display a cloud game 1 page can be reduced. If the cloud game 1 instance is not pre-deployed in the server 10b, after the server 10b receives the start instruction from the user client 21, the server 10b needs to create a cloud game 1 instance for the user A in the server, and start the created cloud game 1 instance.

Similarly, the terminal device 10c shown in FIG. 2, in some instances, may be an electronic device used by the user B. One or more user clients associated with cloud games of different types may be integrated in the terminal device 10c. For example, if a user client 23 in the terminal device 10c is associated with a cloud game 2, an icon of the user client 23 in the terminal device 10c may be an icon of cloud game 2. When a user B wants to play the cloud game 2, the user may perform a triggering operation on the user client 23 in the terminal device 10c. In this case, the terminal device 10c can obtain, in a connected state, a start instruction generated in the user client 23 in response to a start operation performed on the user client 23, and then transmit the start instruction to the server 10b. In this case, a cloud game 2 instance may be created for or allocated to the user B in the server 10b (that is, a cloud game client 24 corresponding to the cloud game 2 may be created for or allocated to the user B), and the cloud game client 24 corresponding to the user B is run in the server 10b. In addition, the user client 23 in the terminal device 10c is also successfully started. To be specific, the user client 23 in the terminal device 10c remains the same running state as the cloud game client 24 in the server 10b. In other words, a plurality of cloud game clients may run in the server 10b, such as the above cloud game client 22 corresponding to the user A and the above cloud game client 24 corresponding to the user B.

As shown in FIG. 2, when running in the server 10b, the cloud game client 22 can execute a game logic in the cloud game 1, and call, through a process in which the cloud game client 22 is located, a rendering interface provided by a GPU driver to perform a rendering operation. A rendered result may be a game picture 20a shown in FIG. 2. A data collection component integrated inside the cloud game client 22 can capture the rendered game picture 20a, and directly transmit the game picture 20a to the user client 21 in the terminal device 10a. After receiving the game picture 20a, the user client 21 in the terminal device 10a can display the game picture.

The cloud game client 22 actually may be considered as a set of software in the server side including complete cloud game functions, and is static. The cloud game client 22 needs to create a corresponding process thereof to run in the server 10b. The process is dynamic. In other words, when the cloud game client 22 in the server 10b needs to be started, the process corresponding to the cloud game client 22 may be created in the server 10b, and the process in which the cloud game client 22 is located may be started. That is to say, running the cloud game client 22 in the server 10b is actually running the process in which the cloud game client 22 is located in the server 10b. The process may be considered as a basic execution entity of the cloud game client 22 in the server 10b. An operating system running in the server 10b may include the GPU driver. The GPU driver can provide a rendering interface for the cloud game client running in the server 10b. For example, the process in which the cloud game client 22 is located needs to call the rendering interface provided by the GPU driver to perform the rendering operation, to obtain the rendered result (for example, the game picture 20a) of the cloud game client 22.

The game picture 20a may include a game control 20c. As shown, the user A can operate the cloud game 1 by triggering the game control 20c. For example, the game control 20c may be configured to control a virtual object 20d in the cloud game 1 to implement functions such as movement, shooting, and invisibility. When the user A performs the triggering operation on the game control 20c, the user client 21 can obtain operation data (object operation data) of the user A, and directly transmit the operation data of the user A to the data collection component integrated inside the cloud game client 22 running in the server 10b. The cloud game client 22 can directly call the operation data of the user A from the data collection component integrated therein, and perform a rendering operation based on the operation data to generate a new game picture. Each frame of game picture rendered by the cloud game client 22 can be transmitted by the cloud game client 22 to the user client 21 in the terminal device 10a in real time for display. Each piece of operation data obtained by the user client 21 can be injected into the cloud game client 22 running in the server 10b, to implement data exchange between the cloud game client 22 in the server 10b and the user client 21 in the terminal device 10a.

As shown in FIG. 2, when running in the server 10b, the cloud game client 24 can execute a game logic in the cloud game 2, and call, through a process in which the cloud game client 24 is located, the rendering interface provided by the GPU driver (the GPU driver is a driver in the operating system running in the server 10b) to perform a rendering operation. A rendered result may be a game picture 20b shown in FIG. 2. A data collection component integrated inside the cloud game client 24 can capture the rendered game picture 20b, directly transmit the game picture 20b to the user client 23 in the terminal device 10c, and display the game picture 20b in the user client 23. After receiving the game picture 20b, the user client 23 in the terminal device 10c can display the game picture.

If the game picture 20b includes a game control 20e, the user B can operate the cloud game 2 by triggering the game control 20e. When the user B performs the triggering operation on the game control 20e, the user client 23 can obtain operation data of the user B, and directly transmit the operation data of the user B to the data collection component integrated inside the cloud game client 24 running in the server 10b. The cloud game client 24 can directly call the operation data of the user B from the data collection component integrated therein, and perform a rendering operation based on the operation data to generate a new game picture. Similarly, each frame of game picture rendered by the cloud game client 24 can be transmitted by the cloud game client 24 to the user client 23 in the terminal device 10c for display. Each piece of operation data obtained by the user client 23 can be injected into the cloud game client 24 running in the server 10b, to perform data exchange between cloud game client 24 in the server 10b and the user client 23 in the terminal device 10c.

In this embodiment of this application, the cloud game client 22 (the cloud game client that generates the game picture 20a) and the cloud game client 24 (the cloud game client that generates the game picture 20b) concurrently running in the server 10b can perform the rendering operation through the respective processes. The rendered results (such as the game picture 20a and the game picture 20b) are independent of each other, and do not affect each other. In addition, the rendered results can be respectively transmitted to the corresponding user clients through the data collection components integrated inside the cloud game clients for display. In other words, the cloud game client 22 and the terminal device 10a used by the user A can directly perform data exchange through the data collection component integrated inside the cloud game client 22, and the cloud game client 24 and the terminal device 10c used by the user B can directly perform data exchange through the data collection component integrated inside the cloud game client 24. The data exchange processes are isolated from each other. It may be learned that, in the technical solution provided in this embodiment of this application, through the data collection component integrated inside each cloud game client, data isolation can be achieved between different cloud game clients. Therefore, data isolation can be achieved for the plurality of cloud game clients running on the server side without a need to arrange a plurality of virtual machines, which can avoid a CPU computing power loss caused by starting a plurality of virtual machines on the server side, increase the utilization rate of the server, and reduce costs of the cloud game.

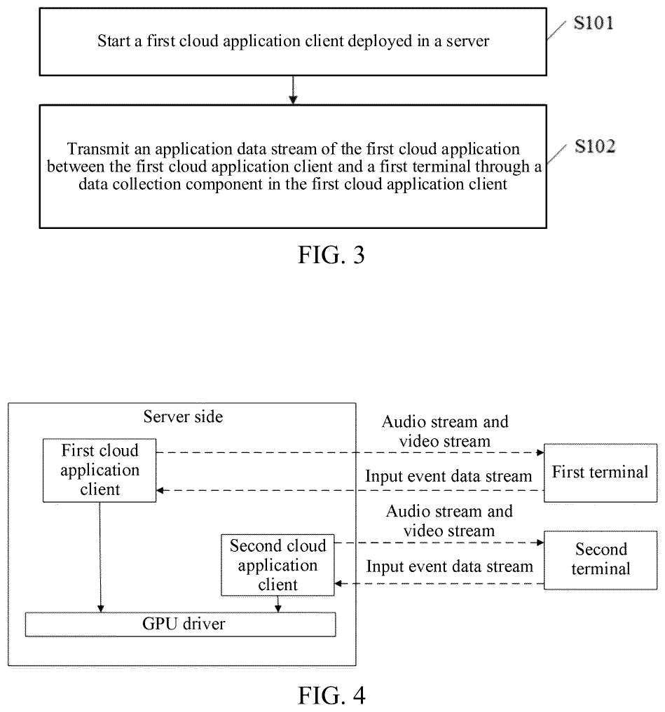

FIG. 3 is a schematic flowchart depicting an example of a data processing method according to various aspects of this application. It may be understood that, the data processing method is performed by a server (for example, the server 10b in the processing system of the cloud application shown in FIG. 1). The data processing method may include the following step S101 to step S102:

Step S101: Start a first cloud application client deployed in the server.

In this embodiment of this application, a plurality of cloud application clients (the cloud application clients herein each may be understood as a cloud application instance, for example, the cloud game client 22 and the cloud game client 24 in the embodiment corresponding to FIG. 2) may be created in the server. Data transmission processes of the plurality of cloud application clients in the server are isolated from each other. It is to be understood that, the cloud application client is a cloud application instance running on the server side, and is configured to execute and implement a relevant operation logic of the cloud application. The expression “data transmission processes of the plurality of cloud application clients are isolated from each other” means that the data transmission processes of the plurality of cloud application clients do not affect each other, and a cloud application client cannot obtain data from another cloud application client.

A running environment provided by the server for the plurality of cloud applications may be a virtualized environment, or may be a non-virtualized environment. The virtualized environment may include a virtual machine, a container, and other types that virtualize an operating system, which is not limited in this application. In this case, the plurality of cloud application clients in the server all run in an emulated operating system of the virtualized environment. The non-virtualized environment may be a real operating system in the server. In this case, the plurality of cloud application clients in the server all run in the real operating system provided by the server.

For ease of understanding, in this embodiment of this application, a detailed description is provided by using any one of the plurality of cloud application clients (which may be referred to as a first cloud application client in this embodiment of this application) as an example. In other words, the first cloud application client is any cloud application client running in the server. The first cloud application client may be considered as a first cloud application instance created in the server. The first cloud application client is a client running on the server side corresponding to a first cloud application. To be specific, the first cloud application client corresponds to the first cloud application, and is configured to perform an application processing task of the first cloud application in the server. In this embodiment of this application, a terminal device configured to perform data exchange with the first cloud application client is referred to as a first terminal. The first terminal may be configured to receive audio/video data generated by the first cloud application client on the server side and output the audio/video data. For example, the first terminal is configured to output cloud application content corresponding to the first cloud application client. The cloud application content may include the audio/video data of the first cloud application client received by the first terminal. The first terminal may be any terminal device in the processing system of the cloud application shown in FIG. 1, which is not limited in this application. The audio/video data may include at least one type of image data and audio data. For example, the audio/video data may be audio data corresponding to the first cloud application client, or the audio/video data may be image data rendered in the first cloud application client, or the audio/video data may include the image data and the audio data generated in the first cloud application client, which is not limited in this application. The image data herein may be a rendered result in the first cloud application client (for example, a game picture rendered in a cloud game client).

Specifically, a user client associated with the first cloud application is installed in the first terminal. The user client herein may be considered as a client that is installed in the terminal device and can provide a first cloud application experience service for a user. When a user using the first terminal wants to use the first cloud application, the user may perform a triggering operation on the user client in the first terminal associated with the first cloud application, to start the user client. For example, the user may enter a login page of the user client installed in the first terminal by clicking/tapping the user client, so that the user may input account information on the login page to log in the first cloud application.

When detecting the triggering operation performed by the user on the user client, the first terminal can generate a first start instruction for the first cloud application, and then transmit the first start instruction to the server. The first start instruction may include application identification information and object information. The application identification information is used for indicating that a cloud application instance that needs to be created or allocated by the server. For example, the application identification information in the first start instruction is used for indicating that the server needs to create or allocate the first cloud application instance (a first cloud application client). The application identification information may be a cloud application identity (ID) or other information that can uniquely identify the first cloud application, which is not limited in this application. The object information may be used for indicating a data exchange object corresponding to the cloud application instance created or allocated by the server based on the first start instruction. For example, the object information in the first start instruction is used for indicating that the data exchange object corresponding to the cloud application instance created or allocated by the server is the first terminal device. More specifically, the data exchange object is the user client in the first terminal device. The object information may include device identification information of the first terminal and an identifier (for example, account information) of the user using the first terminal, which is not limited in this application.

After receiving the first start instruction transmitted by the first terminal, the server can create or allocate the first cloud application client for the first terminal based on the application identification information in the first start instruction, that is, deploy the first cloud application client in the server. Based on the object information in the first start instruction, the first cloud application client may be started, which actually may be considered as starting a process of establishing the first cloud application client in the server. It may be understood that, after the server side starts the first cloud application client, the user client in the first terminal can successfully start the first cloud application, and a progress status of the first cloud application in the user client remains consistent with a progress status of the first cloud application client in the server. Real-time data transmission needs to be performed between the user client in the first terminal and the first cloud application client running in the server. For example, each frame of image data rendered in the first cloud application client can be transmitted from the first cloud application client to the user client in the first terminal, each piece of object operation data inputted by the user in the user client of the first terminal can be transmitted to the first cloud application client in the server, and the first cloud application client and the user client in the first terminal can directly perform data exchange with each other. In this way, data transmission paths in the data exchange process between the first cloud application client and the user client are reduced, and a response time in the data exchange process is reduced. Therefore, it can be ensured that the progress statuses of the first cloud application client and the user client are always consistent, thereby improving smoothness of the audio/video data outputted by the user client and operation sensitivity in the user client, and increasing a user retention rate of the cloud application.

S102: Transmit an application data stream of the first cloud application between the first cloud application client and the first terminal through a data collection component in the first cloud application client.

Specifically, since a plurality of cloud application clients can run in the server, that is, one or more cloud application clients can further run in the server in addition to the first cloud application client, during data exchange between the first cloud application client and the first terminal (which may specifically be the user client in the first terminal associated with the first cloud application), it needs to be ensured that the data exchange process is isolated from a data exchange process of another cloud application client. Therefore, in this embodiment of this application, the data collection component is integrated in each cloud application client. The data collection component is an execution component that is integrated inside the cloud application client and is configured to perform data exchange with a corresponding terminal device. In other words, direct data exchange between the cloud application client in the server and the corresponding terminal device thereof is implemented through the data collection component. Such a data exchange manner can avoid exclusive occupation of a display device, an audio device, and an input device by the cloud application client. In other words, it can be ensured that a data exchange process between each cloud application client and a corresponding terminal device thereof is independent of each other regardless of whether the plurality of the cloud application clients concurrently run in the real operating system provided by the server or concurrently run in the same virtualized environment (for example, a virtual machine) provided by the server. In this way, a utilization rate of the server can be increased when each cloud application client runs normally.

In the data exchange process between the first cloud application client and the first terminal, the application data stream of the first cloud application can be transmitted between the first cloud application client and the first terminal through the data collection component integrated inside the first cloud application client. The application data stream herein is the data exchanged between the first cloud application client and the first terminal during running of the first cloud application. For example, the data collection component integrated inside the first cloud application client can capture the audio/video data generated by the first cloud application client, and transmit the captured audio/video data to the user client in the first terminal. After obtaining the object operation data inputted by the user through the user client, the user client can transmit the object operation data to the data collection component integrated inside the first cloud application client. Then, another component in the first cloud application client (a component in the first cloud application client other than the data collection component) can call the object operation data from the data collection component. The audio/video data and the object operation data herein are the application data stream in the first cloud application.

The application data stream in the first cloud application may include an audio/video stream and an operation data stream (which may also be referred to as an input data stream). The operation data stream may be composed of the object operation data (which may also be referred to as input event data) generated by the first terminal based on a triggering operation in a cloud application display page. The audio/video stream may include at least one of a video stream and an audio stream. The video stream may be composed of a series of image data rendered by the first cloud application client, and the audio stream may be composed of audio data generated by the first cloud application client. The audio data herein and the above image data may be referred to as audio/video data. In other words, the audio/video stream may be composed of audio/video data.

The first terminal is configured to output cloud application content corresponding to the first cloud application. The cloud application content is to-be-displayed content generated based on the above application data stream. The cloud application content, for example, may be a video image generated based on the video stream in the application data stream, or may be audio generated based on the audio stream in the application data stream.

The data collection component may include a rendering capturing component and an operation processing component, or the data collection component may be a comprehensive component in which a function of the rendering capturing component and a function of the operation processing component are integrated, which is not limited in this application. In some aspects, the rendering capturing component may include an image capturing component and an audio capturing component, or the rendering capturing component may be a comprehensive component in which a function of the image capturing component and a function of the audio capturing component are integrated, which is not limited in this application. When the rendering capturing component includes the image capturing component and the audio capturing component, the image capturing component may be configured to capture the image data rendered in the first cloud application client, and the audio capturing component may be configured to capture the audio data generated by the first cloud application client. The captured audio data and image data can be transmitted to the first terminal together. When the rendering capturing component is the comprehensive component in which the function of the image capturing component and the function of the audio capturing component are integrated, the rendering capturing component may be configured to capture the audio/video data (for example, the audio data and the video data) generated by the first cloud application client, and transmit the captured audio/video data to the first terminal. The operation processing component may be configured to receive the object operation data captured by the user client of the first terminal, and inject the received object operation data into the first cloud application client.

In some aspects, the application data stream may include the audio/video data generated by the first cloud application client. The server can call, through a process to which the first cloud application client belongs, a rendering interface provided by a GPU driver in an operating system running on the server side, and perform a rendering processing on page display data (which may be considered as data that needs to be displayed to a user, for example, a virtual object, a game function control, and game scene data in a cloud game) in the first cloud application client based on the rendering interface, to obtain image data corresponding to the first cloud application client. The image data may be stored in a rendering buffer corresponding to the first cloud application client. Each cloud application client running in the server may correspond to one or more rendering buffers. The rendering buffer may be configured to temporarily store image data rendered by a corresponding cloud application client thereof.

In some aspects, during running of the first cloud application client on the server side, the first cloud application client can further generate audio data corresponding to the rendered image data. The audio data may be stored in an audio buffer corresponding to the first cloud application client. The server can allocate an independent audio buffer to each cloud application client configured to generate audio data. The audio buffer may be configured to temporarily store audio data generated by a corresponding cloud application client thereof. The audio buffer may be considered as a system memory in the operating system running on the server side. If image data and audio data are generated in the first cloud application client, the image data and the audio data may be used as the audio/video data corresponding to the first cloud application client. If the first cloud application client does not generate the audio data corresponding to the image data, rendered image data may be used as the audio/video data of the first cloud application client.

In one or more aspects, rendering processing corresponding to the first cloud application client actually may be understood as follows: The process in which the first cloud application client is located in the server performs a rendering operation by calling the rendering interface provided by the GPU driver. A rendered result may include rendered pictures in the first cloud application client. The rendered pictures may be used as the image data corresponding to the first cloud application client. The rendered image data may be stored in the rendering buffer corresponding to the first cloud application client. It may be understood that, each time the process in which the first cloud application client is located renders a picture, the picture may be stored in the rendering buffer, and the data collection component (for example, the rendering capturing component) can capture the rendered picture from the rendering buffer, and transmit the rendered picture used as the audio/video data of the first cloud application client to the first terminal for display.

In some aspects, if the first cloud application client generates the audio data corresponding to the image data during running, the audio data may be stored in the audio buffer corresponding to the first cloud application client. The data collection component integrated inside the first cloud application client can capture the audio data from the audio buffer, and transmit the obtained image data and audio data used as the audio/video data corresponding to the first cloud application client to the first terminal together. In other words, the audio/video data of the first cloud application client can be transmitted between the first cloud application client and the first terminal through the data collection component. Correspondingly, after receiving the audio/video data, the first terminal can display a corresponding image based on the image data therein, and play corresponding audio based on the audio data therein.

In some aspects, the application data stream may include the object operation data generated by the first terminal. A display page (which may also be referred to as a cloud application display page) of the first cloud application client can be displayed in the first terminal. The cloud application display page may be configured to output the audio/video data received by the first terminal. The user can perform a triggering operation based on the audio/video data outputted by the cloud application display page, for example, perform a triggering operation (for example, a touching operation such as click/tap, flick, and touch and hold, or a non-touching operation such as a voice and a gesture, which is not limited in this application) based on the audio/video data displayed on the cloud application display page. In this case, the first terminal can generate object operation data for the first cloud application in response to the triggering operation performed on the audio/video data. The first terminal can directly transmit the object operation data to the data collection component (for example, the operation processing component) in the first cloud application client, and the data collection component injects the object operation data into the first cloud application client, to execute a service logic corresponding to the object operation data. In other words, the object operation data can be transmitted between the first terminal and the first cloud application client through the data collection component.

In some aspects, it is assumed that the plurality of cloud application clients running in the server further include a second cloud application client. The second cloud application client may be considered as a second cloud application instance created in the server. In this embodiment of this application, a terminal device configured to perform data exchange with the second cloud application client is referred to as a second terminal. The second terminal may be configured to receive audio/video data generated by the second cloud application client on the server side, and output the received audio/video data in the second terminal. For example, the second terminal can output a cloud application display page corresponding to the second cloud application client. The second terminal may alternatively be any terminal device in the processing system of the cloud application shown in FIG. 1, which is not limited in this application.

A user client associated with the second cloud application is installed in the second terminal. The user client herein may be considered as a client that is installed in the terminal device and can provide a second cloud application experience service for a user. When a user using the second terminal wants to use the second cloud application, the user may perform a triggering operation on the user client in the second terminal associated with the second cloud application. In this case, after detecting the triggering operation performed by the user on the user client, the second terminal can generate a second start instruction for the second cloud application, and then transmit the second start instruction (which may include application identification information corresponding to the second cloud application, device identification information of the second terminal, account information of the user using the second terminal, and the like) to the server.

After receiving the second start instruction transmitted by the second terminal, the server can create or allocate the second cloud application client for the second terminal based on the second start instruction, and start the second cloud application client created or allocated by the server for the second terminal. For example, after creating or allocating the second cloud application client, a corresponding process may be established for the second cloud application client, and the process in which the second cloud application client is located is started. It may be understood that, after the server side starts the second cloud application client, the user client in the second terminal can successfully start the second cloud application, and a progress status of the second cloud application in the user client remains consistent with a progress status of the second cloud application client in the server.

A data collection component may be integrated inside the second cloud application client running in the server. Through the data collection component integrated inside the second cloud application client, an application data stream in the second cloud application can be transmitted between the second cloud application client and the second terminal. A data exchange process between the second cloud application client and the second terminal is similar to the above data exchange process between the first cloud application client and the first terminal, which is not described in detail herein. It is to be understood that, in addition to the first cloud application client and the second cloud application client, another cloud application client may be further created in the server. A quantity and types of cloud application clients running in the same server are not limited in this application. The first cloud application and the second cloud application involved in the above may be the same cloud application, or may be different cloud applications, which is not limited in this application.

FIG. 4 is a schematic diagram of data exchange of a cloud application according to aspects of this application. In this embodiment of this application, a description is provided by using an example in which 2 cloud application clients (a first cloud application client and a second cloud application client) concurrently run on a server side. In FIG. 4, the first cloud application client and a first terminal are objects between which data exchange is performed, and the second cloud application client and a second terminal are objects between which data exchange is performed.

The first cloud application client and the second cloud application client running in the server can call, through respective processes in which the first cloud application client and the second cloud application client are located, a rendering interface provided by a GPU driver to perform a rendering operation. The GPU driver is a driver in an operating system running on the server side. When the first cloud application client runs on the server side, the process in which the first cloud application client is located can directly call the rendering interface provided by the GPU driver to perform the rendering operation. Rendered image data may be stored in a rendering buffer allocated by the server for the first cloud application client. When the second cloud application client runs on the server side, the process in which the second cloud application client is located can directly call the rendering interface provided by the GPU driver to perform the rendering operation. Rendered image data may be stored in a rendering buffer allocated by the server for the second cloud application client. In other words, the rendering operation of each cloud application client running in the server is completed in the process in which the cloud application client is located, and the rendering operations of different cloud application clients are independent of each other, and do not affect each other. When the rendering interfaces called by the processes in which different cloud application clients are located are rendering interface provided by the same GPU driver, scheduling of the rendering interface by the processes in which the different cloud application clients are located may be controlled by the operating system running on the server side, so that a plurality of cloud application clients can use the GPU resources separately. In other words, by calling the rendering interfaces based on the respective processes in which the plurality of cloud application clients are located to perform the rendering operation, the plurality of cloud application clients in the server can share the GPU hardware device, and another additional device (for example, an emulated display device, an emulated audio device, and an emulated input device) do not need to be created, which can save server resources to a largest degree.

Similarly, the first cloud application client and the second cloud application client running in the server can generate audio data corresponding to rendered image data through the respective processes in which the first cloud application client and the second cloud application client are located. The generated audio data may be respectively stored in audio buffers respectively corresponding to the cloud application clients. For example, the audio data generated by the process in which the first cloud application client is located is stored in the audio buffer corresponding to the first cloud application client, and the audio data generated by the process in which the second cloud application client is located is stored in the audio buffer corresponding to the second cloud application client. In this way, exclusive occupation of an audio device by each cloud application client can be avoided, which can increase a utilization rate of the server.

Since a data collection component is integrated inside each of the first cloud application client and the second cloud application client running in the server, data stream isolation between the plurality of cloud application clients can be ensured through the data collection component integrated inside each cloud application client. The image data stored in the rendering buffer corresponding to the first cloud application client can form a video stream, which is captured and directly transmitted to the first terminal by the data collection component integrated inside the first cloud application client. In other words, the data collection component integrated inside the first cloud application client captures the image data in the rendering buffer, and transmits the image data to the first terminal. The audio data stored in the audio buffer corresponding to the first cloud application client can form an audio stream, which is captured and directly transmitted to the first terminal by the data collection component integrated inside the first cloud application client. In other words, the data collection component integrated inside the first cloud application client captures the audio data in the audio buffer, and transmits the audio data to the first terminal. The data collection component integrated inside the first cloud application client can capture the image data and the audio data in parallel, and transmit the image data and the audio data to the first terminal together. Input event data (for example, object operation data) generated by the first terminal based on a triggering operation in a display page corresponding to the first cloud application client is captured by the first terminal, and then directly transmitted to the first cloud application client for subsequent processing. For example, the input event data can be directly transmitted to the data collection component integrated inside the first cloud application client. Through the data exchange between the first cloud application client and the first terminal based on the data collection component in the first cloud application client, exclusive occupation of a display device, an audio device, and an input device can be avoided, data transmission paths can be reduced, and performance and a response speed can be improved.

A data exchange process between the second cloud application client running in the server and the second terminal is the same as the above data exchange process between the first cloud application client and the first terminal, which is not described in detail herein. A quantity of cloud application clients that may be created in the server is the same as a quantity of cloud application instances that need to be created in the server. Data exchange between the cloud application clients and corresponding terminal devices thereof can be performed independently, and do not affect each other.

In this embodiment of this application, through the data collection component integrated inside the cloud application client, the application data stream can be directly transmitted between the cloud application client and the corresponding terminal device thereof. In this way, exclusive occupation of a display device, an audio device, and an input device by the cloud application client can be avoided, so that a plurality of cloud application clients can concurrently run in a server, which can increase a usage rate of the server, save resources of the server, and reduce usage costs of the cloud application.

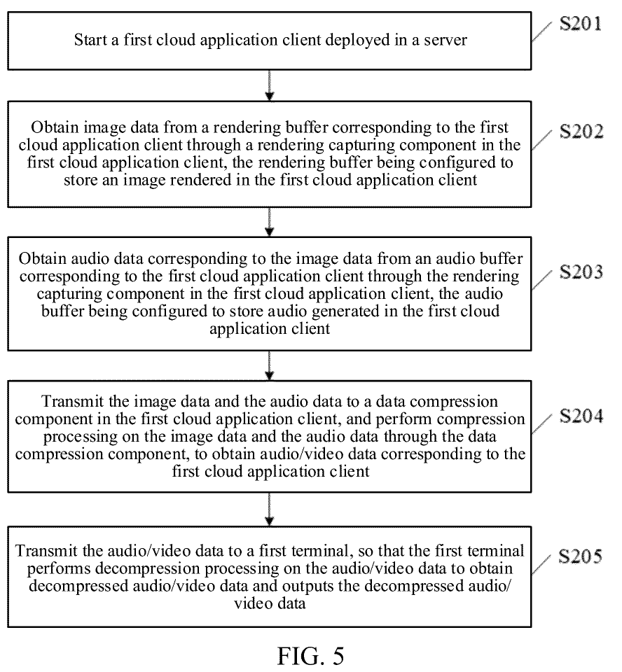

FIG. 5 is a schematic flowchart of another data processing method according to aspects of this application. It may be understood that, the data processing method is performed by a server (for example, the server 10b in the processing system of the cloud application shown in FIG. 1). The data processing method may include the following step S201 to step S205:

Step S201: Start a first cloud application client deployed in the server.

For a specific implementation process of step S201, reference may be made to step S101 in the embodiment corresponding to FIG. 3. The details are not described herein.

Step S202: Obtain image data from a rendering buffer corresponding to the first cloud application client through a rendering capturing component in the first cloud application client, the rendering buffer being configured to store an image rendered in the first cloud application client.

In this embodiment of this application, a data exchange process between the first cloud application client and a corresponding first terminal thereof is described by using an example in which a data collection component integrated inside the first cloud application client includes the rendering capturing component and an operation processing component. Audio/video data generated by the first cloud application client running in the server may be captured by the rendering capturing component integrated inside the first cloud application client. In this embodiment of this application, a transmission process of the audio/video data between the first cloud application client and the first terminal is described by using an example in which the audio/video data includes image data and audio data.

Specifically, when a process in which the first cloud application client is located performs a rendering operation by calling a rendering interface provided by a GPU driver, and temporarily stores rendered image data into the corresponding rendering buffer of the first cloud application client, the rendering capturing component integrated inside the first cloud application client correspondingly can capture the rendered image data from the rendering buffer. For example, the rendering capturing component integrated inside the first cloud application client can perform real-time monitoring on a data storage status of the rendering buffer. Once monitoring new image data that is stored in the rendering buffer, the rendering capturing component integrated inside the first cloud application client can capture the new image data stored in the rendering buffer. For example, the rendering capturing component can monitor the storage status of the rendering buffer through a function (the function, for example, may be an existing general-purpose function, or may be a method such as a customized timer, which is not limited in this application). When it is monitored through the function that the storage status of the rendering buffer changes, it is determined that the data stored in the rendering buffer is changed. In this case, the rendering capturing component can capture image data that causes the change from the rendering buffer.

It may be understood that, one or more rendering buffers may correspond to the first cloud application client. A quantity of rendering buffers corresponding to each cloud application client running in the server is not limited in this application. When the process in which the first cloud application client is located can store the rendered image data into the one or more rendering buffers corresponding to the first cloud application client based on a preset rule (which may be preset based on an actual requirement, and is not limited in this application), the one or more rendering buffers can be cyclically overwritten and used.

For example, when one rendering buffer (the rendering buffer may be denoted as T1) corresponds to the first cloud application client, image data D1 rendered by the process in which the first cloud application client is located may be stored in the rendering buffer T1. In this case, the rendering capturing component integrated inside the first cloud application client can capture the image data D1 in the rendering buffer T1 and transmit the image data D1 to the first terminal. The process in which the first cloud application client is located further performs a rendering operation to obtain image data D2. The image data D2 may also be stored in the rendering buffer T1. In this case, the image data D2 can overwrite the previously stored image data D1. In other words, the image data stored in the rendering buffer T1 is always latest image data rendered in the first cloud application client.

In some aspects, when a plurality of rendering buffers (which, for example, may include a rendering buffer T1, a rendering buffer T2, and a rendering buffer T3) correspond to the first cloud application client, the image data D1 rendered by the process in which the first cloud application client is located may be stored in the rendering buffer T1. In this case, the rendering capturing component integrated inside the first cloud application client can capture the image data D1 in the rendering buffer T1, and transmit the image data D1 to the first terminal. The process in which the first cloud application client is located further performs a rendering operation to obtain image data D2. The image data D2 may be stored in the rendering buffer T2. The rendering capturing component can capture the image data D2 in the rendering buffer T2, and transmit the image data to the first terminal. Similarly, subsequently rendered image data D3 may be stored in the rendering buffer T3, and subsequently rendered image data D4 may be stored in the rendering buffer T1. In this case, the image data D4 can overwrite the previously stored image data D1, and so on. The image data rendered in the first cloud application client can be successively stored into the above three rendering buffers. In this way, each piece of image data rendered in the first cloud application client can be temporarily stored in the rendering buffer for a period of time (for example, a time interval at which the image data is successively stored into in three rendering buffers), which can avoid omitted capturing of the image data by the rendering capturing component.

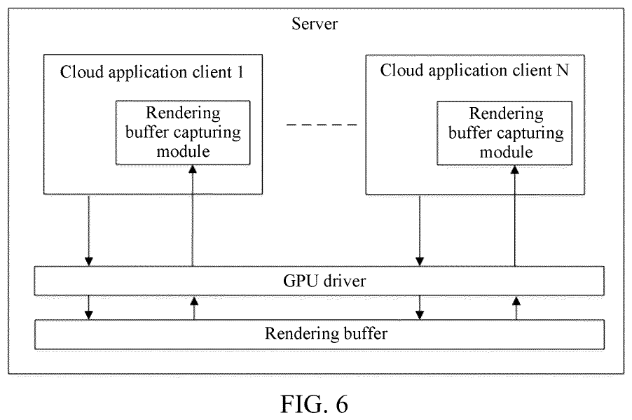

FIG. 6 is a schematic diagram of capturing image data by a rendering capturing component integrated inside a cloud application client according to aspects of this application. As shown in FIG. 6, N cloud application clients (N may be an integer greater than 1), such as a cloud application client 1, a cloud application client 2, . . . , a cloud application client N, concurrently run in a server. A corresponding rendering buffer may be allocated to each cloud application client running in the server. For example, the cloud application client 1 may correspond to a rendering buffer 1, and the cloud application client N may correspond to a rendering buffer N. The rendering buffer corresponding to each cloud application client can store image data obtained through a rendering operation performed by a process in which each cloud application client is located by calling a rendering interface provided by a GPU driver. A rendering buffer capturing module (which may be considered as an image capturing component included in a rendering capturing component) may be integrated in each cloud application client. Captured image data is transmitted to a user client in a corresponding terminal device for display. For example, a rendering buffer capturing module integrated in the cloud application client 1 can transmit, after capturing image data D5, which could have been previously generated and/or captured by the cloud application client 1, the GPU, or a combination thereof, the image data D5 to a terminal device corresponding to the first cloud application client 1 for display. A rendering buffer capturing module integrated in the cloud application client N can transmit, after capturing image data D6 generated in the cloud application client N, the image data D6 to a terminal device corresponding to the first cloud application client N for display.

In some aspects, a process of capturing the image data from the rendering buffer by the rendering capturing component integrated inside the first cloud application client may include the following: Data attribute information of the rendering buffer corresponding to the first cloud application client may be obtained. A texture resource object may be created in the rendering capturing component of the first cloud application client based on the data attribute information. Then the image data in the rendering buffer corresponding to the first cloud application client may be encapsulated into the texture resource object. Through encapsulation of the image data in the rendering buffer into the texture resource object, the texture resource object can be set as a shared texture resource, so that another component (for example, a data compression component) in the first cloud application client can access the image data in the rendering buffer and perform compression processing on the image data, thereby implementing data sharing between different components in the first cloud application client. The data attribute information may include information such as an image width, am image height, and a pixel format in the first cloud application client. For example, the rendering capturing component integrated inside the first cloud application client can obtain the data attribute information of the rendering buffer through a data exchange interface, create a texture resource object based on the data attribute information, and then encapsulate the image data in the rendering buffer into the texture resource object. In this way, it can be ensured that the texture resource object is in a one-to-one correspondence with the image data in the rendering buffer, and authenticity of the image data is maintained.

Step S203: Obtain audio data corresponding to the image data from an audio buffer corresponding to the first cloud application client through the rendering capturing component in the first cloud application client, the audio buffer being configured to store audio generated in the first cloud application client.

Specifically, during start of the first cloud application client in the server, the server can allocate the corresponding audio buffer for the first cloud application client. The process in which the first cloud application client is located can generate audio data corresponding to the rendered image data, and store the audio data into the audio buffer corresponding to the first cloud application client. The rendering capturing component (or an audio capturing component included in the rendering capturing component) integrated inside the first cloud application client can capture the audio data in the audio buffer. A process of capturing the audio data from the audio buffer by the rendering capturing component is similar to the above process of capturing the image data from the rendering buffer. For example, an audio resource object may be created in the rendering capturing component, and the audio data of the audio buffer is encapsulated into the audio resource object. Details are not described herein.

S204: Transmit the image data and the audio data to a data compression component in the first cloud application client, and perform compression processing on the image data and the audio data through the data compression component to obtain the audio/video data corresponding to the first cloud application client.

Specifically, after capturing the image data and the audio data, the rendering capturing component integrated inside the first cloud application client can transmit the captured image data and audio data to the data compression component integrated inside the first cloud application client. Compression processing is performed on the image data and the audio data through the data compression component, so that compressed image data and compressed audio data can be obtained. The compressed image data and the compressed audio data may be referred to as the audio/video data corresponding to the first cloud application client.

After obtaining image data (which may be considered as a video frame in a video stream generated by the first cloud application client), the rendering capturing component integrated inside the first cloud application client can perform compression processing on the obtained image data through the data compression component integrated inside the first cloud application client, to obtain compressed image data. For example, the obtained image data may be compressed into an H264 format (which is a video compression format), or the obtained image data may be compressed into another video compression format, which is not limited in this application. Through the compression processing of the image data obtained by the rendering capturing component, an amount of to-be-transmitted data can be reduced, thereby reducing bandwidth pressure.

After obtaining audio data, the rendering capturing component integrated inside the first cloud application client can perform compression processing on the obtained audio data through the data compression component integrated inside the first cloud application client, to obtain compressed audio data. For example, the obtained audio data may be compressed into an Opus format (which is an audio compression format), or the obtained audio data may be compressed into another video compression format, which is not limited in this application. Through the compression processing of the audio data obtained by the rendering capturing component, an amount of to-be-transmitted data can be reduced, thereby reducing bandwidth pressure.

It is to be understood that, the operating system running in the server may be considered as a running environment of the plurality of cloud application clients of the server side. The operating system running in the server may be a Windows system, or may be a Linux system, or may be an operating system of another type, which is not limited in this application. In other words, the plurality of cloud application clients involved in this embodiment of this application can run normally in operating systems of different types, and unnecessarily run in an operating system of a specific type. Due to the different types of the operating systems running in the server, functions used by the rendering capturing component integrated inside the first cloud application client for transmitting the image data and the audio data to the data compression component may be different. In other words, in the operating systems of different types, the rendering capturing component can transmit the image data and the audio data to the data compression component by using different functions. For ease of understanding, a process of transmitting the image data to the data compression component by the rendering capturing component is described below by using an example in which the operating system running in the server is the Windows operating system (a process of transmitting the audio data to the data compression component by the rendering capturing component is similar to the process of transmitting the image data to the data compression component by the rendering capturing component, and therefore only the image data is used as an example for description in this embodiment of this application).

In one or more aspects, in the first cloud application client, after capturing the image data from the rendering buffer, the rendering capturing component can encapsulate the image data into the texture resource object created in the rendering capturing component. A fence object may be further created in the rendering capturing component. The fence object may be configured to monitor a data status in the texture resource object. Alternatively, the fence object may be understood as a prompt mechanism configured to prompt the data compression component that the audio/video data corresponding to the texture resource object completes the rendering operation.

The implementation process of transmitting the image data from the rendering capturing component to the data compression component may include the following: The texture resource object may be set as a shared texture resource. For example, the texture resource object may be set as the shared texture resource through calling of a CreateSharedHandle method (a handle in a Windows system configured to create a shared resource). To be specific, image data corresponding to the texture resource object may be set as a shared resource, so that the data compression component can access the image data corresponding to the shared texture resource texture, thereby implementing resource sharing among different components in the first cloud application client, and reducing a data processing time of the image data on the server side. Certainly, through the shared texture resource, resource sharing between different programs can be further implemented. For example, resource sharing between the rendering capturing component inside the first cloud application client and an external independent program can be implemented. Similarly, the fence object may be set as a shared fence. For example, the fence object may also be set as a shared fence through calling of the CreateSharedHandle method, so that the data compression component can access the shared fence, to obtain a completion status of the rendering operation of the image data corresponding to the shared texture resource texture. In this way, the data compression component can obtain the rendered image data in a timely manner, and transmit the compressed image data to the first terminal in a timely manner, to reduce a time for transmitting the image data from the first cloud application client to the first terminal, thereby ensuring that a progress status in the first terminal is consistent with a progress status in the first cloud application client. Further, the shared texture resource and the shared fence may be imported into the data compression component in the first cloud application client. For example, the shared texture resource may be accessed through an OpenSharedResource method (a shared resource access method in the Windows system), and the shared fence may be accessed through an OpenSharedFence method (a shared fence access method in the Windows system).

When the shared fence monitors that the data status in the shared texture resource is a completed state, the shared fence can transmit a prompt signal to the data compression component. The data compression component obtains the image data corresponding to the shared texture resource based on the prompt signal, and performs compression processing on the image data, to obtain compressed image data. In other words, after each picture is rendered in the shared texture resource, the shared fence prompts the data compression component to perform compression processing on the rendered picture to obtain a compressed picture.

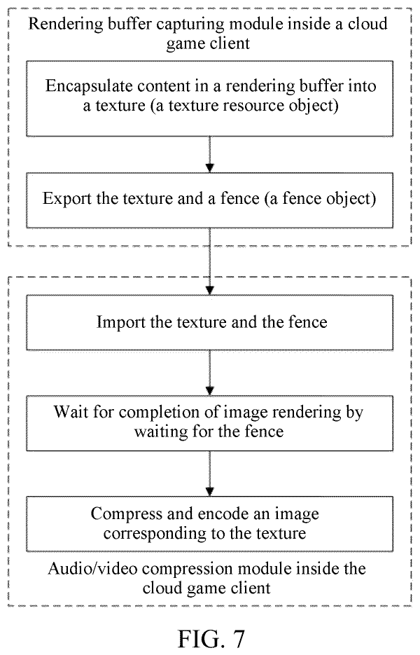

FIG. 7 is a schematic diagram of compression processing of image data in a cloud application client according to aspects of this application. For ease of understanding, processing of the image data in the rendering capturing component and the data compression component integrated inside the cloud application client is described below by using PC cloud gaming (the PC cloud gaming indicates that a cloud game client runs in a Windows system, that is, the operating system running in the server is the Windows system) as an example. As shown in FIG. 7, a rendering buffer capturing module (a rendering capturing component) in a cloud game client (for example, the first cloud application client) running in the server can create a texture resource object, and then encapsulate content in the rendering buffer into the texture resource object, that is, encapsulate image data in the rendering buffer into the texture resource object.

Further, the texture resource object may be set as a shared texture resource and a fence object may be set as a shared fence through calling of a CreateSharedHandle method, and the shared texture resource and the shared fence are exported from the rendering buffer capturing module in the cloud game client. An audio/video compression module (that is, a data compression component) in the cloud game client can import the shared texture resource and the shared fence, for example, access the shared texture resource through an OpenSharedResource method, and access the shared fence through an OpenSharedFence method. The audio/video compression module needs to wait for the shared fence to transmit a prompt signal. If the prompt signal transmitted by the shared fence is received, it indicates that a rendering operation performed on image data (for example, a rendered picture) corresponding to the shared texture resource is completed, so that the image data corresponding to the shared texture resource may be compressed and encoded, that is, the rendered image may be compressed and encoded through the data compression component, to obtain compressed image data.

Step S205: Transmit the audio/video data to the first terminal, so that the first terminal performs decompression processing on the audio/video data to obtain decompressed audio/video data and outputs the decompressed audio/video data.

Specifically, after the audio/video data is obtained through the data compression component, the audio/video data can be transmitted to the first terminal. Specifically, the audio/video data can be transmitted to a user client in the first terminal. After receiving the audio/video data, the user client in the first terminal can perform decompression processing on the audio/video data to obtain decompressed audio/video data, that is, the audio/video data before the compression processing, and output the audio/video data in the user client. Through compression and encoding of the image data and the audio data generated in the first cloud application client by using the data compression component integrated inside the first cloud application client, interaction between the first cloud application client and an external application can be reduced, thereby reducing transmission paths of the audio/video data and improving performance and a response speed.

In some aspects, if no data compression component is integrated inside the first cloud application client, compression processing may be performed on the image data and the audio data obtained by the rendering capturing component integrated inside the first cloud application client by using a data compression application in the operating system run by the server. For example, the image data and the audio data obtained by the rendering capturing component may be transmitted to the data compression application, and compression processing may be performed on the image data and the audio data through the data compression application, to obtain compressed image data and compressed audio data may be obtained. The compressed image data and the compressed audio data may be referred to as the audio/video data corresponding to the first cloud application client. The data compression application and the first cloud application client are independent of each other in the server. The audio/video data obtained through the data compression application may also be transmitted to the first terminal, so that the first terminal can perform decompression processing on the audio/video data to obtain decompressed audio/video data, and then outputs the decompressed audio/video data in the first terminal. A process of transmitting the image data and the audio data generated by the first cloud application client from the rendering capturing component to the data compression application is similar to the above process of transmitting the image data and the audio data from the rendering capturing component to the data compression component, which is not described herein again. Through compression and encoding of the image data and the audio data in the first cloud application client by using the external data compression application of the first cloud application client, that is, through reuse of the data compression application in the existing cloud application solution, a development workload of the cloud application client can be reduced.

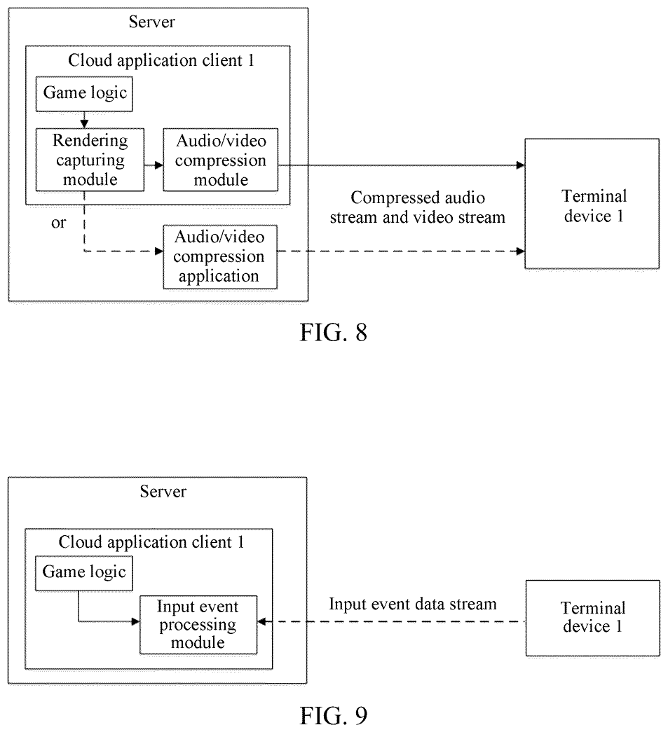

FIG. 8 is a schematic structural diagram of data compression of a cloud application client in a server according to aspects of this application. The data compression structure in the server is described below by using a cloud game client as an example. As shown in FIG. 8, a cloud game client 1 (for example, the first cloud application client) runs in the server, and a device performing data exchange with the cloud game client 1 is a terminal device 1 (for example, the first terminal). During running, the cloud game client 1 can execute a corresponding game logic (for example, the above service logic), and a process in which the cloud game client 1 is located can call the rendering interface to perform a rendering operation. Rendered image data may be stored in a rendering buffer, and audio data corresponding to the image data generated by the process in which the cloud game client 1 is located may be stored in an audio buffer. A rendering capturing module (a rendering capturing component) integrated inside the cloud game client 1 can capture the image data from the rendering buffer and capture the audio data from the audio buffer.

If an audio/video compression module (a data compression component) is integrated inside the cloud game client 1, the audio data and the image data obtained by the rendering capturing module can be transmitted to the audio/video compression module (the data compression component) for compression processing, and compressed audio data and video data are transmitted to the terminal device 1 (for example, the first terminal) as the audio/video data corresponding to the first cloud application client. In some aspects, if no audio/video compression module is integrated inside the cloud game client 1, the audio data and the image data obtained by the rendering capturing module may be transmitted to an audio/video compression application (that is, the data compression application) in the operating system in the server for compression processing, and compressed audio data and video data are transmitted to the terminal device 1 as the audio/video data corresponding to the first cloud application client.

In one or more aspects, the data collection component integrated inside the first cloud application client may include an operation processing component (which may also be referred as an input event processing module). In this case, the application data stream transmitted between the first cloud application client and the first terminal may include object operation data generated by the first terminal. The object operation data may include an instruction generated by the first terminal based on a triggering operation in a cloud application display page corresponding to the first cloud application client. When the first terminal outputs the received audio/video data, the audio/video data may be displayed in the user client of the first terminal. For example, the user client in the first terminal can display the cloud application display page corresponding to the first cloud application client, and play a sound effect corresponding to the first cloud application client. The cloud application display page may be configured to output the audio/video data received by the first terminal.

The audio/video data outputted by the cloud application display page may include different types of functional controls. When a user performs a triggering operation on a functional control on the cloud application display page, the first terminal can generate operation data of the user (that is, object operation data), and then directly transmit the object operation data to the operation processing component in the first cloud application client. In this case, the first cloud application client running in the server can receive, through the internal operation processing component, the object operation data transmitted by the first terminal, and execute the corresponding service logic in the first cloud application client by calling the object operation data in the operation processing component. In other words, the object operation data in the operation processing component integrated inside the first cloud application client may be called by another component in the first cloud application client for subsequent processing, thereby implementing a relevant service logic.

FIG. 9 is a schematic diagram of receiving object operation data by an operation processing component integrated inside a cloud application client according to aspects of this application. The operation processing component integrated inside the cloud application client is described below still by using a cloud game client as an example. As shown in FIG. 9, a cloud game client 1 (for example, the first cloud application client) runs in the server, and a device performing data exchange with the cloud game client 1 is a terminal device 1 (for example, the first terminal). After obtaining input event data (that is, object operation data) from a game display page (for example, a cloud application display page) corresponding to the cloud game client 1, the terminal device 1 can transmit the obtained input event data to an input event processing module (that is, the operation processing component) integrated inside the cloud game client 1. The input event data in the input event processing module may be called by another module in the cloud game client 1. In this embodiment of this application, the input event data generated by the terminal device 1 can be directly transmitted to the cloud game client 1, which reduces transmission paths of the input event data, and improves performance and a response speed of the cloud game client 1.

In this embodiment of this application, a plurality of cloud application clients can concurrently run in the server, and the first cloud application client of the plurality of cloud application clients can directly transmit the audio/video data generated by the first cloud application client to the corresponding first terminal through the rendering capturing component integrated inside the first cloud application client, and the object operation data generated by the first terminal can be directly transmitted to the operation processing component integrated inside the first cloud application client. In other words, each cloud application client can directly perform data exchange with the corresponding terminal device. In this way, exclusive occupation of a display device, an audio device, and an input device by the cloud application client is avoided, and data transmission paths between the cloud application client and the corresponding terminal device are reduced, thereby improving the performance and the response speed. Concurrently running a plurality of cloud application clients in the same server can save resources of the server, increase a usage rate of the server, thereby reducing usage costs of the cloud application. Since data streams corresponding to the cloud application client do not need to generate an interactive operation with an emulated display device, audio device, or input device, intermediate conversion of data among the display device, the audio device, and the input device in the operating system run by the server can be reduced, which facilitates implementation of a multi-touch requirement of the cloud application user client in the terminal device.

It may be understood that, in a specific implementation of this application, relevant information of a user (for example, user account information, and information about a terminal device used by a user) may be involved. When this embodiment of this application is applied to a specific product or technology, a user permission or consent needs to be obtained, and collection, use, and processing of the relevant data need to comply with relevant laws, regulations, and standards of relevant countries and regions.

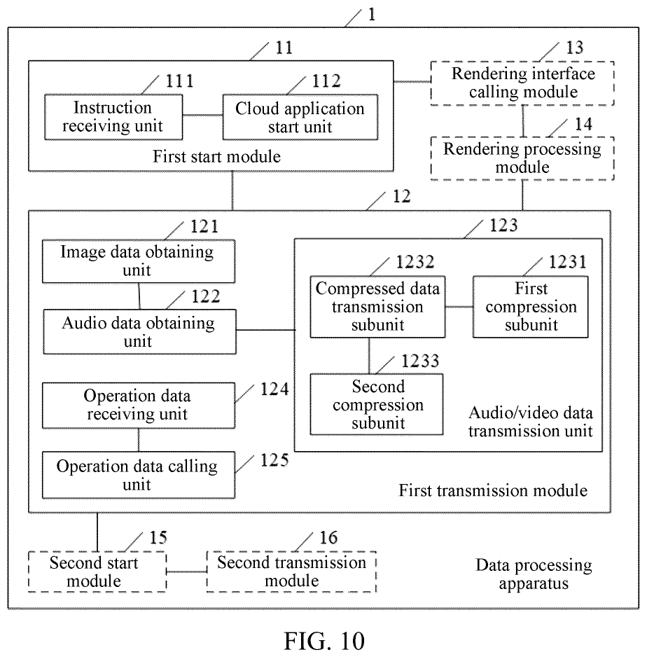

FIG. 10 is a schematic structural diagram of a data processing apparatus according to aspects of this application. The data processing apparatus runs in a server, a plurality of cloud application clients are deployed in the server, data transmission processes of the plurality of cloud application clients are isolated from each other, and the plurality of cloud application clients include a first cloud application client. As shown in FIG. 10, the data processing apparatus 1 may include a first start module 11 and a first transmission module 12.

The first start module 11 is configured to start the first cloud application client deployed in the server.

The first transmission module 12 is configured to transmit an application data stream of a first cloud application between the first cloud application client and a first terminal through a data collection component in the first cloud application client.

For specific function implementations of the first start module 11 and the first transmission module 12, reference may be made to step S101 to step S102 in the embodiment corresponding to the FIG. 3. The details are not described herein.

In one or some aspects, the data collection component includes a rendering capturing component, and the application data stream includes audio/video data.

The first transmission module 12 includes an image data obtaining unit 121, an audio data obtaining unit 122, and an audio/video data transmission unit 123.

The image data obtaining unit 121 is configured to obtain image data from a rendering buffer corresponding to the first cloud application client through the rendering capturing component in the first cloud application client, the rendering buffer being configured to store an image rendered in the first cloud application client.

The audio data obtaining unit 122 is configured to obtain audio data corresponding to the image data from an audio buffer corresponding to the first cloud application client through the rendering capturing component in the first cloud application client, the audio buffer being configured to store audio generated in the first cloud application client.

The audio/video data transmission unit 123 is configured to determine audio/video data corresponding to the first cloud application client based on the image data and the audio data, and transmit the audio/video data to the first terminal, so that the first terminal outputs the audio/video data.

In some aspects, the image data obtaining unit 121 may be specifically configured to:
obtain data attribute information of the rendering buffer corresponding to the first cloud application client, and create a texture resource object in the rendering capturing component of the first cloud application client based on the data attribute information; and
encapsulate the image data in the rendering buffer corresponding to the first cloud application client into the texture resource object.

For specific function implementations of the image data obtaining unit 121, the audio data obtaining unit 122, and the audio/video data transmission unit 123, reference may be made to step S202 to step S205 in the embodiment corresponding to the FIG. 5. The details are not described herein.

In one or some aspects, the data processing apparatus 1 may further include a rendering interface calling module 13 and a rendering processing module 14.

The rendering interface calling module 13 is configured to call a rendering interface provided by a graphics processing unit (GPU) driver in the server through a process to which the first cloud application client belongs.

The rendering processing module 14 is configured to perform rendering processing on page display data in the first cloud application client based on the rendering interface to obtain image data corresponding to the first cloud application client, and store the image data into the rendering buffer corresponding to the first cloud application client.

In some aspects, the plurality of cloud application clients further include a second cloud application client. The data processing apparatus 1 may further include a second start module 15 and a second transmission module 16.

The second start module 15 is configured to start, in a case that a second start instruction transmitted by a second terminal is received, the second cloud application client in the server based on the second start instruction.

The second transmission module 16 is configured to transmit an application data stream of a second cloud application between the second cloud application client and the second terminal through a data collection component in the second cloud application client.

For specific function implementations of the rendering interface calling module 13, the rendering processing module 14, the second start module 15, and the second transmission module 16, reference may be made to step S102 in the embodiment corresponding to the FIG. 3. The details are not described herein.

In one or some aspects, the audio/video data transmission unit 123 may include a first compression subunit 1231 and a compressed data transmission subunit 1232.

The first compression subunit 1231 is configured to transmit the image data and the audio data to a data compression component in the first cloud application client, and perform compression processing on the image data and the audio data through the data compression component to obtain the audio/video data corresponding to the first cloud application client.

The compressed data transmission subunit 1232 is configured to transmit the audio/video data to the first terminal, so that the first terminal performs decompression processing on the audio/video data to obtain decompressed audio/video data and outputs the decompressed audio/video data.

Alternatively, the audio/video data transmission unit 123 may include a second compression subunit 1233 and the compressed data transmission subunit 1232.

The second compression subunit 1233 is configured to transmit the image data and the audio data to a data compression application, and perform compression processing on the image data and the audio data through the data compression application to obtain the audio/video data corresponding to the first cloud application client, the data compression application and the first cloud application client being independent of each other in the server.

The compressed data transmission subunit 1232 is configured to transmit the audio/video data to the first terminal, so that the first terminal performs decompression processing on the audio/video data to obtain decompressed audio/video data and outputs the decompressed audio/video data.

The image data is located in the texture resource object created in the rendering capturing component. The rendering capturing component further includes a fence object. The fence object is configured to monitor a data status in the texture resource object.

The first compression subunit 1231 is specifically configured to:
set the texture resource object in the rendering capturing component as a shared texture resource, set the fence object in the rendering capturing component as a shared fence, and import the shared texture resource and the shared fence into the data compression component in the first cloud application client;
transmit a prompt signal to the data compression component in a case that the shared fence monitors that the data status in the shared texture resource is a completed state; and
obtain image data corresponding to the shared texture resource in the data compression component based on the prompt signal, obtain the audio data in the rendering capturing component, and perform compression processing on the image data and audio data to obtain the audio/video data corresponding to the first cloud application client.

For specific function implementations of the first compression subunit 1231, the compressed data transmission subunit 1232, and the second compression subunit 1233, reference may be made to step S204 to step S205 in the embodiment corresponding to the FIG. 5. The details are not described herein.

In one or some aspects, the data collection component includes an operation processing component, and the application data stream includes object operation data. The object operation data includes an instruction generated by the first terminal based on a triggering operation in a cloud application display page corresponding to the first cloud application client.

The first transmission module 12 may include an operation data receiving unit 124 and an operation data calling unit 125.

The operation data receiving unit 124 is configured to receive the object operation data transmitted by the first terminal through the operation processing component in the first cloud application client.

The operation data calling unit 125 is configured to execute a service logic in the first cloud application client by calling the object operation data in the operation processing component.

For specific function implementations of the operation data receiving unit 124 and the operation data calling unit 125, reference may be made to step S205 in the embodiment corresponding to the FIG. 5. The details are not described herein.

In one or some aspects, the first start module 11 may include an instruction receiving unit 111 and a cloud application start unit 112.

The instruction receiving unit 111 is configured to receive a first start instruction transmitted by the first terminal, and deploy the first cloud application client in the server based on application identification information in the first start instruction.

The cloud application start unit 112 is configured to start the first cloud application client in the server based on object information in the first start instruction.

For specific function implementations of the instruction receiving unit 111 and the cloud application start unit 112, reference may be made to step S102 in the embodiment corresponding to the FIG. 3. The details are not described herein.

In this embodiment of this application, a plurality of cloud application clients can concurrently run in the server, and the first cloud application client of the plurality of cloud application clients can directly transmit the audio/video data generated by the first cloud application client to the corresponding first terminal through the rendering capturing component integrated inside the first cloud application client, and the object operation data generated by the first terminal can be directly transmitted to the operation processing component integrated inside the first cloud application client. In other words, each cloud application client can directly perform data exchange with the corresponding terminal device. In this way, exclusive occupation of a display device, an audio device, and an input device by the cloud application client is avoided, and data transmission paths between the cloud application client and the corresponding terminal device are reduced, thereby improving the performance and the response speed. Concurrently running a plurality of cloud application clients in the same server can save resources of the server, increase a usage rate of the server, thereby reducing usage costs of the cloud application. Since data streams corresponding to the cloud application client do not need to generate an interactive operation with an emulated display device, audio device, or input device, intermediate conversion of data among the display device, the audio device, and the input device in the operating system run by the server can be reduced, which facilitates implementation of a multi-touch requirement of the cloud application user client in the terminal device.

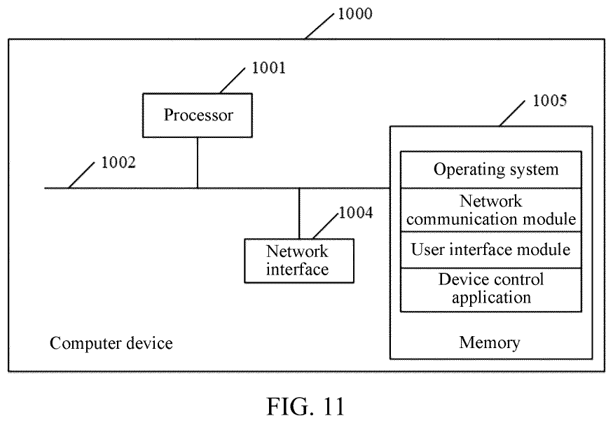

FIG. 11 is a schematic structural diagram of a computer device according aspects of this application. As shown in FIG. 11, a computer device 1000 may be a server. The computer device 1000 may include a processor 1001, a network interface 1004, and a memory 1005. In addition, the computer device 1000 may further include at least one communication bus 1002. The communication bus 1002 is configured to implement connection and communication between these components. In some aspects, the network interface 1004 may include a standard wired interface and a wireless interface (such as a Wi-Fi interface). The memory 1005 may be a high-speed random access memory (RAM), or may be a non-volatile memory, for example, at least one magnetic disk memory. In some aspects, the memory 1005 may alternatively be at least one storage apparatus located away from the above processor 1001. As shown in FIG. 11, the memory 1005 serving as a computer-readable storage medium may include an operating system, a network communication module, a user interface module, and a device control application.

In the computer device 1000 shown in FIG. 11, the network interface 1004 can provide a network communication function. The processor 1001 may be configured to call the device control application stored in the memory 1005, to implement the data processing method provided in the aspects of this application.

It is to be understood that, the computer device 1000 described in this embodiment of this application can perform the above description of the data processing method in the embodiment corresponding to any one of FIG. 3 and FIG. 5, or can perform the above description of the data processing apparatus 1 in the embodiment corresponding to FIG. 10. The details are not described herein. In addition, beneficial effects of using the same method are not described in detail herein.

In addition, various aspects include computer-readable storage media that store computer programs configured to be executed by the above data processing apparatus 1. The computer program includes program instructions. When executing the program instructions, a processor can perform the above description of the data processing method in the embodiment corresponding to any one of FIG. 3 and FIG. 5. The details are not described herein. In addition, beneficial effects of using the same method are not described in detail herein. For technical details not disclosed in the embodiment of the computer-readable storage medium involved in this application, reference is made to the description of the method embodiment of this application. In an example, the program instructions may be deployed on a computing device for execution, or executed on a plurality of computing devices at one location, or executed on a plurality of computing devices distributed at a plurality of locations and connected by a communication network. The plurality of computer devices distributed at the plurality of locations and connected by the communication network can form a blockchain system.

In addition, aspects of this disclosure include computer program products or computer programs. Computer program products or programs may include computer instructions. The computer instructions may be stored in a computer-readable storage medium. A processor of a computer device reads the computer instructions from the computer-readable storage medium, and the processor can execute the computer instructions to cause the computer device to perform the above description of the data processing method in the embodiment corresponding to any one of FIG. 3 and FIG. 5.

For brevity, the above method aspects are described as a series of action combinations. However, a person skilled in the art is to be aware that this application is not limited to the order of the described actions, because some steps may be performed in another sequence or simultaneously according to this application. In addition, a person skilled in the art is further to be aware that, the aspects described in the specification are exemplary aspects, and the involved actions and modules are not necessarily required by this application.

The steps of the method in the aspects of this application may be reordered, merged, and deleted based on an actual need.

The modules of the apparatus of the aspects of this application may be merged, divided, and deleted based on an actual need.

A person of ordinary skill in the art can understand that all or some of processes of the methods in the above aspects may be implemented by instructing relevant hardware through a computer program. The computer program may be stored in a computer-readable storage medium. The computer program, when executed, may include the processes of the aspects of the methods described above. The storage medium may be a magnetic disk, an optical disc, a read-only memory (ROM), a RAM, or the like.

The above disclosure is merely exemplary aspects of this application, and certainly is not intended to limit the scope of the claims of this application. Therefore, equivalent variations made in accordance with the claims of this application fall within the scope of this application.

What is claimed is:

1. A method, comprising:
instantiating a plurality of cloud application clients on a server;
isolating data transmission processes of the plurality of the cloud application clients;
executing a first cloud application client; and
sending an application data stream of a first cloud application between the first cloud application client and a first terminal through a data collection component in the first cloud application client.

2. The method of claim 1, wherein the data collection component further comprises a rendering capturing component, and wherein the application data stream further comprises audio/video data.

3. The method of claim 2, further comprising:
determining image data from a rendering buffer using the rendering capturing component;
determining data attribute information of the rendering buffer corresponding to the first cloud application client;
creating a texture resource object in the rendering capturing component of the first cloud application client based on the data attribute information; and
encapsulating the image data in the rendering buffer corresponding to the first cloud application client into the texture resource object.

4. The method of claim 2, wherein determining the image data comprises:
sending the image data and the audio data to a data compression component;
processing, by the data compression component, the image and audio data to obtain the audio/video data; and
sending the audio/video data to the first terminal, so that the first terminal performs decompression processing on the audio/video data to obtain decompressed audio/video data and outputs the decompressed audio/video data.

5. The method of claim 4, wherein the image data is located in a texture resource object created in the rendering capturing component, and wherein the rendering capturing component further comprises a fence object configured to monitor a data status in the texture resource object.

6. The method of claim 5, further comprising:
setting the texture resource object in the rendering capturing component as a shared texture resource;
setting the fence object in the rendering capturing component as a shared fence;
importing the shared texture resource and the shared fence into the data compression component in the first cloud application client;
sending a signal to the data compression component; and
determining image data corresponding to the shared texture resource in the data compression component based on the signal;
determining the audio data in the rendering capturing component; and
compressing the audio and image data.

7. The method of claim 1, wherein the sending comprises:
obtaining, via the rendering capturing component, image data from a rendering buffer corresponding to the first cloud application client,;
obtaining, via the rendering capturing component, audio data corresponding to the image data from an audio buffer corresponding to the first cloud application client,
sending, to the first terminal and based on first cloud application client, audio/visual data.

8. The method of claim 7, wherein the rendering buffer is configured to store an image rendered in the first cloud application client.

9. The method of claim 7, wherein the audio buffer is configured to store audio generated in the first cloud application client.

10. The method according to claim 1 further comprising:
rendering display data in the first cloud application client to obtain image data corresponding to the first cloud application client, and storing the image data into the rendering buffer.

11. The method of claim 10, further comprising:
calling a rendering interface provided by a graphics processing unit (GPU) driver in the server through a process to which the first cloud application client belongs.

12. The method of claim 1, further comprising
sending an application data stream of a first cloud application between the first cloud application client and a first terminal through a data collection component in the first cloud application client comprises:
receiving the object operation data transmitted by the first terminal through the operation processing component in the first cloud application client; and
executing a service logic in the first cloud application client by calling the object operation data in the operation processing component.

13. The method of claim 1, wherein executing the first cloud application comprises:
receiving a first start instruction transmitted by the first terminal, and deploying the first cloud application client in the server based on application identification information in the first start instruction; and
executing the first cloud application client in the server based on object information in the first start instruction.

14. The method of claim 1, wherein the plurality of cloud application clients further comprise a second cloud application client.

15. The method of claim 14, further comprising:
executing, based on receipt of a second start instruction from a second terminal, a second cloud application client in the; and
sending an application data stream of a second cloud application between the second cloud application client and the second terminal through a data collection component in the second cloud application client.

16. An apparatus, comprising:
a computing device configured to execute computer instructions comprising:
executing plurality of cloud application clients,
isolating data transmission processes of the plurality of cloud application clients, wherein the plurality of cloud application clients comprising a first cloud application client, and the apparatus comprising:
a first start module, configured to start the first cloud application client deployed in the server; and
a first transmission module, configured to transmit an application data stream of a first cloud application between the first cloud application client and a first terminal through a data collection component in the first cloud application client.

17. A non-transitory computer-readable medium containing computer instructions that, when executed by one or more processors, cause the one or more processors to perform actions comprising:
instantiating a plurality of cloud application clients on a server;
isolating data transmission processes of the plurality of the cloud application clients;
executing a first cloud application client deployed in the server; and
sending an application data stream of a first cloud application between the first cloud application client and a first terminal through a data collection component in the first cloud application client.

18. The computer-readable medium of claim 18, wherein the computer readable medium further contains instructions that cause the data collection component to render capturing component, and wherein the application data stream further comprises audio/video data.

19. The computer-readable medium of claim 18, wherein the computer-readable medium contains further instructions that cause the one or more processors to:
determining image data from a rendering buffer corresponding to the first cloud application client using the rendering capturing component;
determining data attribute information of the rendering buffer corresponding to the first cloud application client;
creating a texture resource object in the rendering capturing component of the first cloud application client based on the data attribute information; and
encapsulating the image data in the rendering buffer corresponding to the first cloud application client into the texture resource object.

20. The computer-readable medium of claim 17, wherein the sending comprises:
obtaining, via the rendering capturing component, image data from a rendering buffer corresponding to the first cloud application client;
obtaining, via the rendering capturing component, audio data corresponding to the image data from an audio buffer corresponding to the first cloud application client; and
sending, to the first terminal and based on first cloud application client, audio/visual data.
